(19) United States
(12) Patent Application Publication
(10) Pub. No.: US 2005/0033563 A1
(43) Pub. Date: Feb. 10, 2005

(54) Statistical eleven-month weather forecasting

(76) Inventor: William Kirk, Easton, PA (US)

Correspondence Address: BLANK ROME LLP, 600 NEW HAMPSHIRE AVENUE, N.W., WASHINGTON, DC, 20037, US

(21) Appl. No.: 10/660,743

(22) Filed: Sep. 12, 2003

Related U.S. Application Data
(60) Provisional application No. 60/492,968, filed on Aug. 7, 2003.

(51) Int. Cl. G06F 17/10

(52) U.S. Cl. 703/2

(57) ABSTRACT

Temperature and precipitation are predicted from temperature and precipitation during the same week in one or two previous years and normal temperature and precipitation during that week. The difference between the previous year's value and the normal value is calculated and used to determine which forecasting formula is used. The result can be prepared in graphical form by time, geography, or both for use in planning advertising, retailer stock purchases, or the like.

### REFERENCE TO RELATED APPLICATION

The present application claims the benefit of U.S. Provisional Patent Application No. 60/492,968, filed Aug. 7, 2003, whose disclosure is hereby incorporated by reference in its entirety into the present disclosure

### FIELD OF THE INVENTION

The present invention is directed to a technique, capable of implementation on a computer, for making weather predictions. The invention includes both the technique for doing so and business methods employing the technique to make predictions useful for retailers.

### DESCRIPTION OF RELATED ART

Retailers and similar businesses plan their business from last year's sales results, and Wall Street encourages this further by tracking their performance relative to the same period a year ago. Most companies are in some way impacted by weather, especially those that sell or produce seasonal merchandise.

Even companies that do not sell seasonal merchandise can be significantly affected by the weather, as consumers are impacted by the weather. An example would be a pizza parlor. Pizza is indirectly weather impacted because consumers call for a pizza delivery in inclement weather. Thus, more rain results in more business at a pizza parlor. Video rentals are weather impacted in a similar way. Inclement winter weather brings a boost to business, as bad weather limits outdoor activities, so consumers tend to remain indoors and watch television.

The location of the business also plays a role in the significance of weather. Big-box retailers are stand-alone destination locations that can be more impacted by weather than stores in a conventional enclosed mall. On a cold or rainy day, people can more easily justify a trip to an enclosed mall, where they can eat, shop for multiple categories of items, or watch a movie, than they can with regard to a stand-alone retailer.

Statistically, weather repeats year-over-year in any given location less than 20% of the time. As an example, December 1993 was cold in New York; December 1994 was near record warm; in 1995 it was one of the coldest Decembers in 100 years; in 1996, near record warm. In 1997, the weather was “normal” (cooler). The government 30-year average is defined as “normal” weather. Unfortunately, it is an average of all the really cold and really warm months thereby making it a measure that rarely occurs. Like last year, “normal” occurs less than 20% of the time for any given location and time.

The December example above shows that very typically weather scenario plays havoc for most companies. For example, suppose that a merchant has sold many coats, jackets, boots and other winter items in New York in December 1993. After the season is over, the merchant will plan next year's coat business. Unfortunately, most companies will simply look at last year's sales and then plan up another 10%. Wall Street is somewhat to blame, as it demands growth. So the merchant heads to China in April the following year and buys a large number of coats, since it sold a large number last year. The coats (all 110% of them) arrive by boat in July are shipped to the distribution centers in August and pushed to the stores for the back-to-school season in September. Now they wait for the cold weather. Unfortunately, it never came in 1994, and now the merchant is stuck with an oversupply of coats. The solution is to mark it down and give it away to clear the merchandise. This eroded most profits for the coat merchant and resulted in a disappointing season. The merchant therefore plans very conservatively for the 1995 season and maybe changes the mix to light weight coats. December 1995 turns out to be coldest December on record. The merchant sells out early and misses what would have been many sure sales. The result is a loss in both profits and good will.

### SUMMARY OF THE INVENTION

It is therefore an object of the invention to improve weather forecasting.

It is another object of the invention to improve weather forecasting over periods of time useful to allow retailers and similar businesses to plan purchases.

To achieve the above and other objects, the present invention is based on the following discovery. The inventor analyzed between 109 and 118 years (depending on location) of temperature data and found a very clear pattern for 260 major markets across the country. The markets are listed in the Appendix. An illustrative example is shown in FIG. 1 for Eastern New York.

The analysis showed the following. First, the weather seldom repeats. If last year was warm (above the normal monthly mean November temperature of 39.5°, which is indicated by the line labeled N), the next year is less likely to be warm or as warm; if last year was cold (below the normal line N), the following year is less likely to be as cold. Second, normal seldom occurs.

These charts very clearly show just how much risk there is for retailers, manufacturers, consumer packaged goods companies and even the pizza makers who plan their business off last year.

Based on the premise that the weather repeats less than 20% of the time (80% of the time it does something different from last year) and most companies plan off last year, the inventor has developed a process (formula) by which to produce a forecast for next year (rolling 11-months out by week) that would be a more accurate measure of future weather vs assuming last year's weather would be the same.

In FIG. 1, the dashed line labeled H (42.20) depicts 1 sigma standard deviation above normal, and the dashed line labeled C (36.80) shows 1 sigma standard deviation below normal. The average monthly swing in temperatures year-over-year is about 5° with the greatest monthly year-over-year swing 10°-15°.

The next step in the process was to confirm that the above monthly trends would hold true at a weekly level, and they do. So if a week was really hot or cold last year in November, the chances that the same week in the future would be hot/cold was still only about 20% likely to repeat.

Weekly normal (based on 109-118 years of data) temperatures values for each of the 260 major markets were created for every month. As an example, the 39.5° monthly normal November mean temperature in Eastern New York would be broken down to a standard 4-week retail November calendar (week ending date Saturdays):

Week ending Nov. 8, 2003, normal weekly mean temperature value is 43°.

Week ending Nov. 15, 2003, normal weekly mean temperature value is 41°.

Week ending Nov. 22, 2003, normal weekly mean temperature value is 38°.

Week ending Nov. 29, 2003, normal weekly mean temperature value is 36°.

The initial monthly process to forecast for next year used the following rules:

If last year November was 2-sigma above the 109-year mean, the forecast for next year would be 70 colder.

If last year was between 1 and 2-sigma above the 109-year mean, the forecast would be 1 sigma colder.

If last year was less than 1-sigma above the 109-year mean, the forecast would be the normal weekly mean temperature.

If last year was less than 1-sigma below the 109-year mean, the forecast would be the normal weekly mean temperature.

If last year was between 1 and 2-sigma below the 109-year mean, the forecast would be 1 sigma warmer.

If last year was 2-sigma below the 109-year mean, the forecast for next year would be 7° warmer.

If last year was within 10 of normal, then take the preceding two-year average for that week and then apply the above rules. So if the year prior was warm and this year normal then the forecast would be toward colder.

The monthly process outlined above was refined in 2002-2003 to allow for the creation of weekly temperature and precipitation forecasts using standard mathematical formulas built off the general findings at the monthly level.

### BRIEF DESCRIPTION OF THE DRAWINGS

A preferred embodiment of the present invention will be set forth in detail with reference to the drawings, in which:

FIG. 1 shows a plot of temperature data used to demonstrate the present invention;

FIG. 2 shows a flow chart of a procedure for forecasting temperature;

FIG. 3 shows a coding scheme used for graphical representations of temperature forecasts;

FIG. 4 shows a flow chart of a procedure for forecasting precipitation;

FIG. 5 shows a coding scheme used for graphical representations of precipitation forecasts;

FIG. 6 shows a schematic diagram of a system on which the preferred embodiment can be implemented; and

FIGS. 7 and 8 show sample publications for presentation of the forecasts.

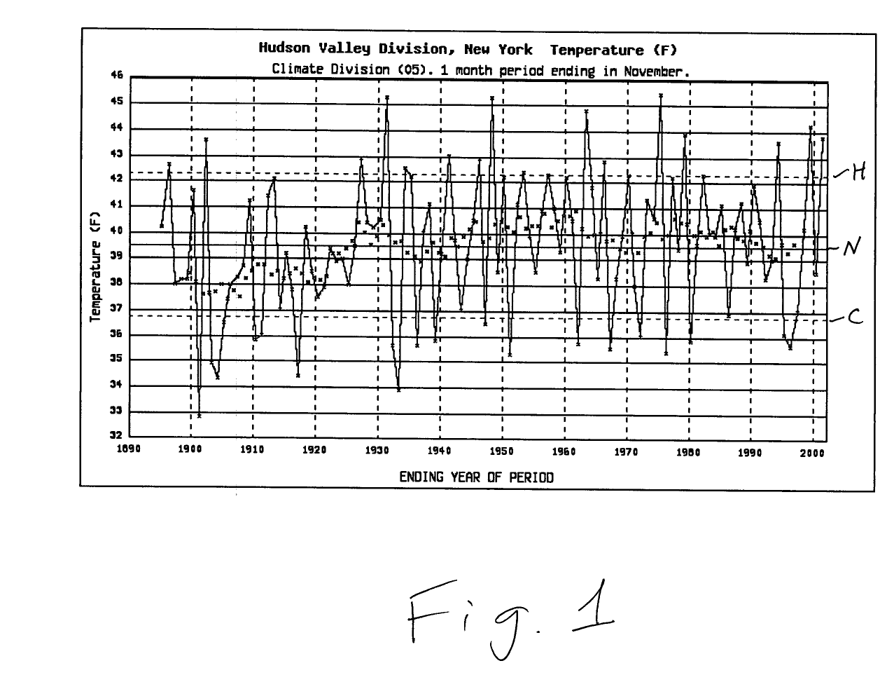

### DETAILED DESCRIPTION OF THE PREFERRED EMBODIMENT

A preferred embodiment of the present invention will be set forth in detail with reference to the drawings.

First, the process for weekly temperature prediction will be performed. Then, the process for weekly precipitation will be performed.

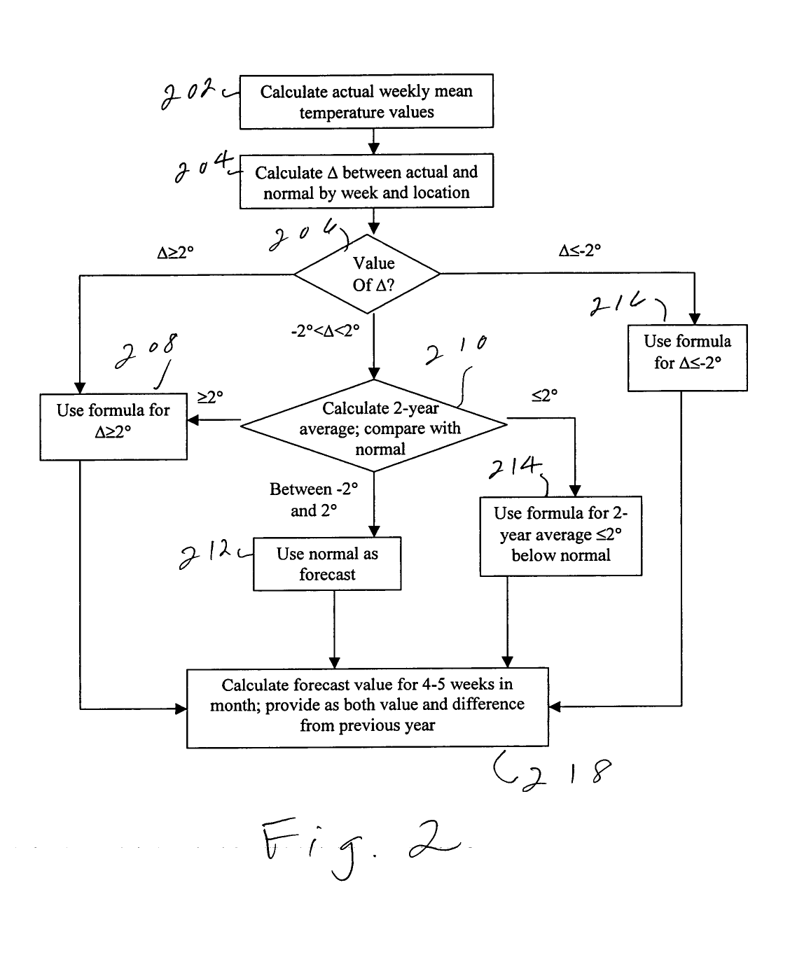

The process for weekly temperature prediction will be explained with reference to the flow chart of FIG. 2.

1. (Step 202) Calculate the actual weekly mean temperature values for each of the 260 markets for last year. If forecasting for June 2004 this process would begin once June 2003 is complete. Adding up the 7 max temperatures and 7 minimum temperatures and dividing by 14 calculate actual weekly mean temperatures.

Note: all aggregations of temperature are applied to a standard retail calendar with a week ending date Saturday.

2. (Step 204) Using the predefined weekly normal mean temperatures (based on a 30-year average for each location, each week) calculate the delta between actual and normal for last year by week by location.

3. Once the delta from last year actual and normal is determined we can calculate the weekly mean temperature forecast for next year using one of the following equations (3.a.-3.d). First, we determine whether the delta value calculated above is greater than equal to two degrees above normal, less than or equal to two degrees below normal, or within two degrees of normal (Step 206). Depending on that determination, one of the following is carried out.
a. If last year was equal to or greater than 20 above normal, complete the following calculation (Step 208):
   LY T_{act}−[(LY T_{act}−Tₙₒᵣₘ)×0.75]=FORECAST
b. If last year was between 2° and −2° of NORMAL, complete the following calculation (Step 210):
   (LLY T_{act}+LY T_{act})/2=2 year average temperature
Compare that result with normal.
   1) If the 2-year average temperature is 2° or more above normal, use equation 3.a (Step 208).
   2) If the 2-year average temperature is still between 2° and −2° of normal, use normal as the forecast (Step 212).
   3) If the 2-year average temperature is −2° or more below normal, use equation 3.c (Step 214).
c. If the 2-year average temperature for the week in question is −2° or more BELOW NORMAL complete the following calculation:
   (LLY T_{act}+LY T_{act})/2+[ABS((((LLY T_{act}+LY T_{act})/2)−Tₙₒᵣₘ)×0.75)]=FORECAST
d. If last year was equal to or less than −2° BELOW NORMAL, complete the following calculation (Step 216):
   LY T_{act}+[ABS((LY T_{act}−Tₙₒᵣₘ)×0.75)]=FORECAST

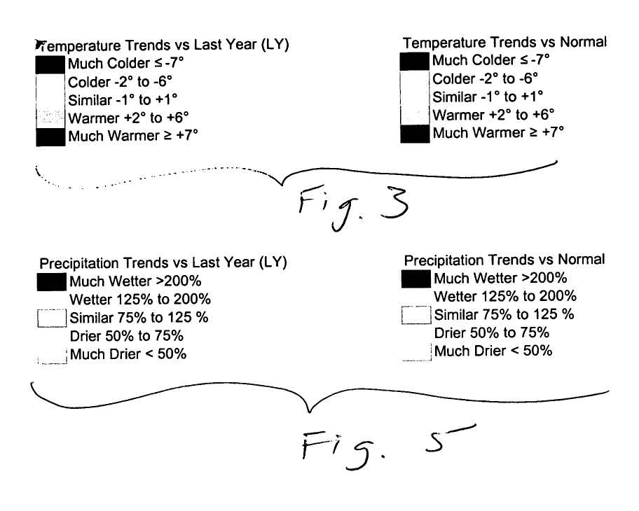

4. The forecast value is calculated for the 4 or 5 weeks that make up the month for each of the 260 locations using the above formulas (Step 218). Forecast values are depicted in visual deliverables both as a value and as a delta from the year prior, using a coding scheme such as that of FIG. 3.

The weekly precipitation prediction process will now be explained with reference to the flow chart of FIG. 4.

5. Calculate the total weekly precipitation for each of the 260 markets for last year (Step 402). Actual total weekly precipitation is calculated by adding up the 7 daily totals for the week.

Note: all aggregations of temperature are applied to a standard retail calendar with a week ending date Saturday.

6. Calculate the delta between last year's actual total weekly precipitation and the normal value (Step 404).

7. Once the delta from last year actual and normal is determined we can calculate the weekly total precipitation forecast for next year using one of the formulas below (7.a.-7.d). First, we determine whether last year's value is 125% or more above normal, 75% or less below normal, or within 75% and 125% of normal (Step 406). Depending on that determination, one of the following is carried out.
a. If last year total weekly precipitation was 125% or more above normal, complete the following calculation (Step 408):
   LY P_{act}−[(LY P_{act}−Pₙₒᵣₘ)×0.75]=FORECAST
b. If last year total weekly precipitation was between 125% and 75% of NORMAL, complete the following calculation (Step 410):
   (LLY P_{act}+LY P_{act})/2=2 year average precipitation
   Compare the result to normal.

1) If the 2-year average precipitation is still 125% or more above normal, use equation 7.a (Step 408).

2) If the 2-year average precipitation is still between 125% and 75% of normal, use the normal weekly value as the forecast (Step 412).

3) If the 2-year average precipitation total is 75% or more below normal, go to equation 7.c (Step 414).
c. If the 2-year average precipitation total for the week in question is 75% or more below normal, complete the following calculation:
   (LLY P_{act}+LY P_{act})/2+[ABS((((LLY P_{act}+LY P_{act})/2)−Pₙₒᵣₘ)×0.75)]=FORECAST
d. If last year was 75% or more below normal, complete the following calculation (Step 416):
   LY P_{act}+[ABS((LY P_{act}−P norm)×0.75)]=FORECAST

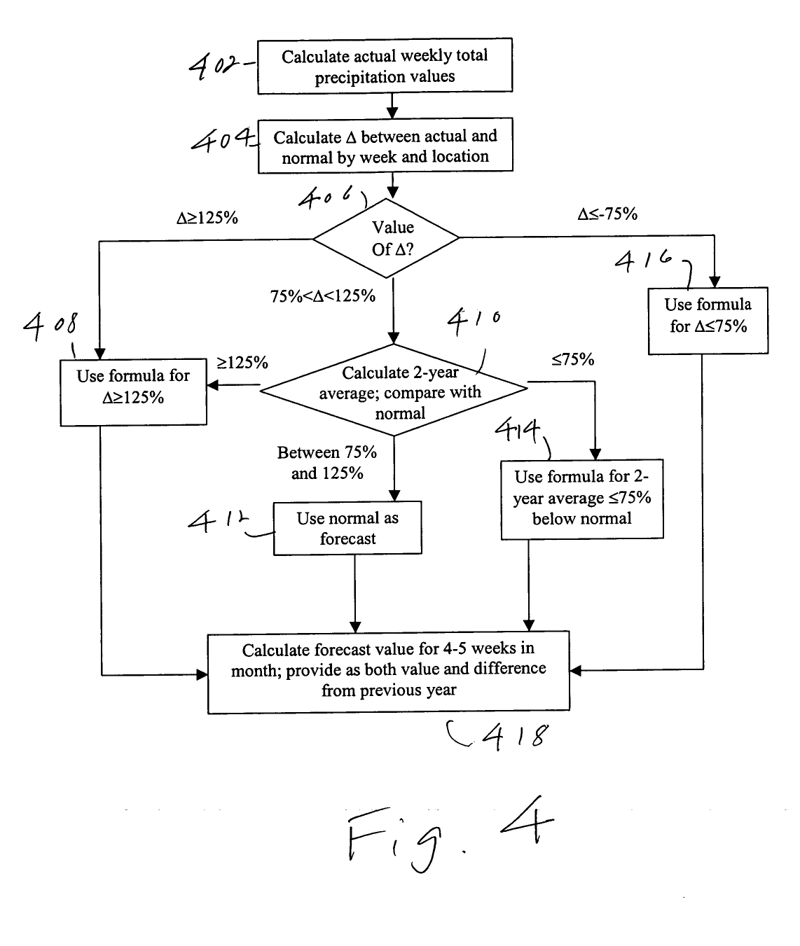

8. The precipitation forecast value is calculated for the 4 or 5 weeks that make up the month for each of the 260 locations using the above formulas (Step 418). Forecast values are depicted in visual deliverables both as a value and as a delta from the year prior using the coding scheme of FIG. 5.

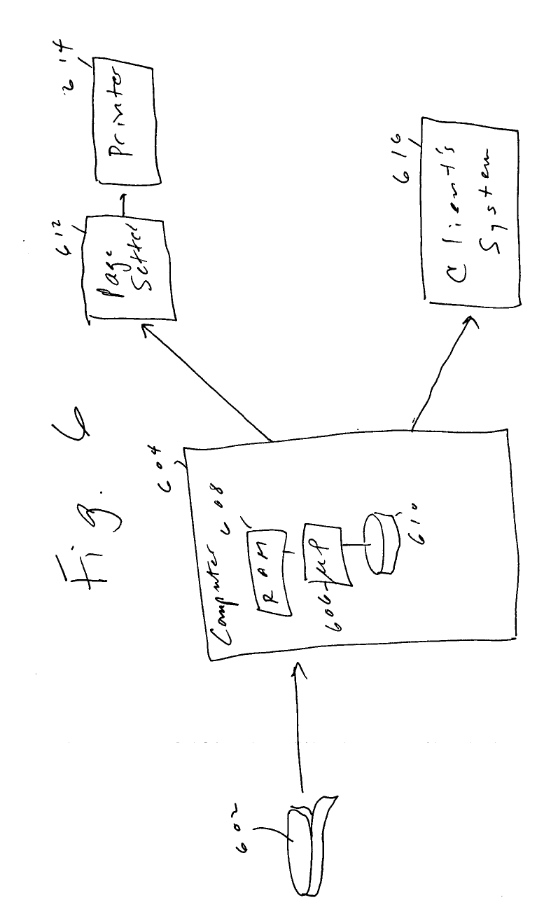

FIG. 6 shows a block diagram of a system on which the preferred embodiment can be carried out. The system 600 receives the raw weather data 602 on any suitable medium or transmission link. The system includes a computer 604 having a microprocessor 606, RAM 608 and persistent storage (e.g., a hard drive) 610 for storing both the weather data 602 and calculation results. The computer 604 can be connected by any suitable communication system to a page setter 612 and printer 614 for producing hard-copy weather reports for mailing to clients. Alternatively, the calculation results can be directly input into a client's system 616 via a virtual private network or the like.

Examples will be given.

### EXAMPLE 1

Last year was 810 in Philadelphia for the week ending July 6^{th}, 2002. Normal weekly temperature is 75° Use equation 3.a.:
LY T_{act}−[(LY T_{act}−Tₙₒᵣₘ)×0.75]=FORECAST
81−[(81−75)×0.75]=
81−4.50=
=76.5° is the FORECAST for next year this same week (weekending Jul. 5, 2003)

### EXAMPLE 2

This past week ending Jan. 18^{th}, 2003, was 25° in Philadelphia. Normal weekly temperature is 32°. Use equation 3.d.:
LY T_{act}+[ABS((LY T_{act}−Tₙₒᵣₘ)×0.75)]=FORECAST
25+[ABS((25−32)×0.75)]=
25+[ABS(−7)×0.75)]
25+5.25=
=30.30 is the FORECAST for next year this same week in Philadelphia

### EXAMPLE 3

This past week ending Jan. 18^{th}, 2003, there was 0.25″ of precipitation. Normal weekly precipitation is 0.83″. Using equation 7.d.:
LY P_{act}+[ABS((LY P_{act}−Pₙₒᵣₘ)×0.75)]=FORECAST
0.25+[ABS ((0.25−0.83)×0.75)=
0.25+0.435=
=0.69″ is the FORECAST for next year this same week in Philadelphia

ACCURACY: Is measured both directionally and if the forecast is closer to actual vs assuming last year.

On average, the directional accuracy of the WEEKLY forecasts over the last 13 years has been 76%. In 2003 to date the weekly directional accuracy is 80%. So, if the forecast implied this November would be colder than last year and it was that is considered an accurate directional forecast. Repeat the process for all markets, all weeks and divide by the total possible correct forecasts to arrive at a percent accuracy value.

The second measure of accuracy is if the forecast is closer to the specific weekly mean temperature than last year. If last year was 45° and our forecast was 38° and actual came in anywhere from 410 or colder we would score it a hit. This is the more strict measure of accuracy. On average this is 68% accurate which is a 3-time improvement over assuming last year. Over the past 13 years this process has been within +/−30 during the volatile winter months and within +/−2° during the summer months.

Precipitation shows less skill due to a lot of factors (it rains everywhere but the airport, spotty thunderstorms, tropical systems, etc.). Precipitation tracks at 61% directionally correct.

This process is in an experimental stage for monthly snowfall trends and shows some skill at a monthly level.

VALUE: With nearly a 4-time more accurate view of future temperature weather trends and three time more accurate precipitation trends by week retailers and manufacturers can plan their business with a lot more intelligence when making key decisions on purchasing product, manufacturing goods, allocating merchandise, timing promotions, timing advertising events, timing marketing activities, labor scheduling, logistics planning (air, ship, barge, rail, truck), etc.

Most weather companies provide a forecast relative to normal, which is tough for a retailer to plan from. In order to plan using a forecast that said it will be warmer than normal next winter they would have to know what “normal” sales are, an impossible measure for most companies. By providing the forecast relative to last year in a weekly aggregate that matches their calendar (i.e. it will be 7° colder than last year for week ending X), they can better plan their seasonal business.

PRODUCTS: As noted above with respect to FIG. 6, calculation results can be output to clients in several ways. Hard-copy reports include a trend report and a sales and marketing planner. Digital data feeds for input into retailers and manufacturers forecasting and planning environments.

Business Applications using these long-range products include the following:

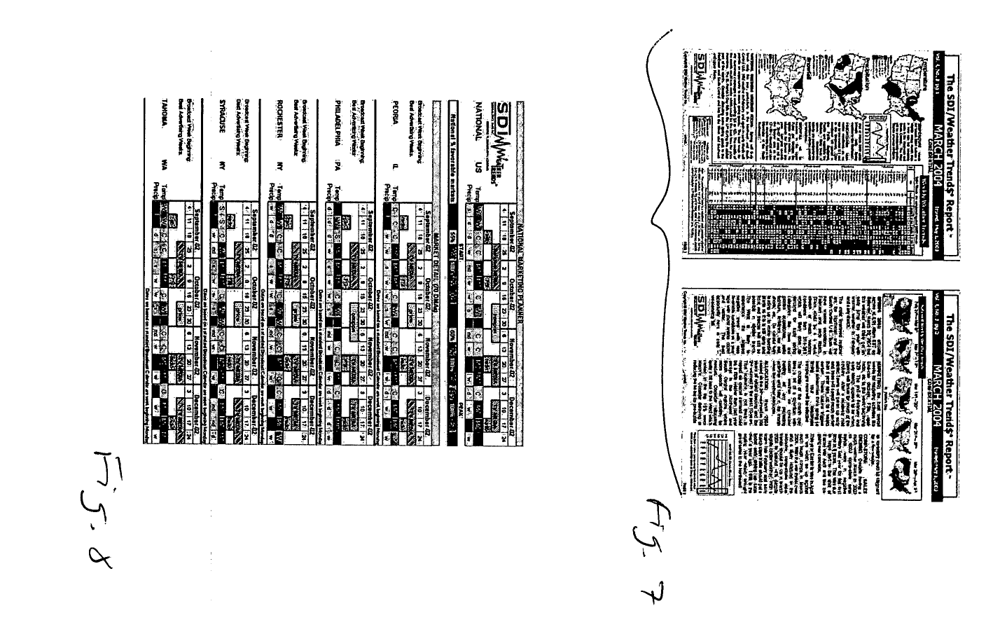

An 11-month ahead weather trend report provides visual representations of the forecast through maps and charts on the expected weather trends across the nation by week and month. These visuals allow retailers and manufacturers to make adjustments on how much product to buy, where to allocate it, when to time a promotion or advertising and when to get out of a product with a markdown. A sample is shown in FIG. 7.

The 11-month ahead weather trend sales and marketing planner provides a time-series view of the forecast by location across many months. This product allows advertising agencies to simply pick out the best weeks to time campaigns with favorable weather and stay clear of the unfavorable periods. Advertising in unfavorable weather for the particular product is ineffective and a waste of advertising dollars. Timing price incentives when the weather is not favorable for sales will help to spur consumer demand. A sample is shown in FIG. 8.

Digital forecasts 11-months ahead by week by location can be imported into business planning, forecasting and replenishment systems. These systems factor in many variables like price, advertising, marketing, economy, last year's sales but seldom factor in a weather component. The weather piece is arguably one of the most important variables for seasonal goods that rely on favorable weather for product sales.

While a preferred embodiment and variations thereon have been disclosed, those skilled in the art who have reviewed the present disclosure will readily appreciate that other embodiments can be realized within the scope of the invention. For example, numerical values are illustrative rather than limiting, as are disclosures of specific hardware and of specific page layouts for printed reports. Therefore, the present invention should be construed as limited only by the appended claims.

APPENDIX
List of Markets

| Market Name | State | Call Sign | Airport Name |
|---|---|---|---|
| Aberdeen | SD | KABR | Aberdeen/Aberdeen Regional Airport |
| Abilene | TX | KABI | Abilene/Abilene Regional Airport |
| Akron-Canton | OH | KCAK | Akron/Akron-Canton Regional Airport |
| Alamosa | CO | KLHX | La Junta/La Junta Municipal Airport |
| Albany | GA | KABY | Albany/Southwest Georgia Regional Airport |
| Albany | NY | KALB | Albany/Albany County Airport |
| Albuquerque | NM | KABQ | Albuquerque/Albuquerque International Airport |
| Alexandria | LA | KESF | Alexandria/Alexandria Esler Regional Airport |
| Allentown | PA | KABE | Allentown/Lehigh Valley International Airport |
| Alpena | MI | KAPN | Alpena/Alpena County Regional Airport |
| Altoona | PA | KAOO | Altoona/Altoona-Blair County Airport |
| Amarillo | TX | KAMA | Amarillo/Amarillo International Airport |
| Asheville | NC | KAVL | Asheville/Asheville Regional Airport |
| Astoria | OR | KAST | Astoria/Astoria Regional Airport |
| Athens | GA | KAHN | Athens/Athens Airport |
| Atlanta | GA | KATL | Atlanta/Hartsfield Atlanta International Airport |
| Atlantic City | NJ | KACY | Atlantic City/Atlantic City International Airport |
| Augusta | GA | KAGS | Augusta/Bush Field |
| Austin | TX | KAUS | Austin/Austin-Bergstrom International Airport |
| Bakersfield | CA | KBFL | Bakersfield/Meadows Field Airport |
| Baltimore | MD | KBWI | Baltimore/Baltimore-Washington International Airport |
| Bangor | ME | KBGR | Bangor/Bangor International Airport |
| Baton Rouge | LA | KBTR | Baton Rouge/Baton Rouge Metropolitan/Ryan Field |
| Beaufort | SC | KNBC | Beaufort/Marine Corps Air Station |
| Beaumont | TX | KBPT | Beaumont/Port Arthur/Southeast Texas Regional Airport |
| Beckley | WV | KBKW | Beckley/Raleigh County Memorial Airport |
| Bellingham | WA | KBLI | Bellingham/Bellingham International Airport |
| Billings | MT | KBIL | Billings/Billings Logan International Airport |
| Binghamton | NY | KBGM | Binghamton/Binghamton Regional Airport |
| Birmingham | AL | KBHM | Birmingham/Birmingham International Airport |
| Bismarck | ND | KBIS | Bismarck/Bismarck Municipal Airport |
| Boise | ID | KBOI | Boise/Boise Air Terminal |
| Boston | MA | KBOS | Boston/Logan International Airport |
| Bowling Green | KY | KBWG | Bowling Green/Bowling Green-Warren County Regional Airport |
| Bozeman | MT | KBZN | Bozeman/Gallatin Field |
| Bridgeport | CT | KBDR | Bridgeport/Sikorsky Memorial Airport |
| Bristol | TN | KTRI | Bristol/Johnson/Kingsport/Tri-City Regional Airport |
| Brownsville | TX | KBRO | Brownsville/Brownsville/South Padre Island International |
| | | | Airport |
| Buffalo | NY | KBUF | Buffalo/Greater Buffalo International Airport |
| Burlington | IA | KBRL | Burlington/Burlington Regional Airport |
| Burlington | VT | KBTV | Burlington/Burlington International Airport |
| Burns | OR | KBNO | Burns/Burns Municipal Airport |
| Butte | MT | KBTM | Butte/Bert Mooney Airport |
| Cape Girardeau | KY | KPAH | Paducah/Barkley Regional Airport |
| Caribou | ME | KCAR | Caribou/Caribou Municipal Airport |
| Casper | WY | KCPR | Casper/Natrona County International Airport |
| Cedar City | UT | KCDC | Cedar City/Cedar City Municipal Airport |
| Cedar Rapids | IA | KCID | Cedar Rapids/Cedar Rapids Municipal Airport |
| Champaign | IN | KHUF | Terre Haute/Terre Haute International Airport-Hulman Field |
| Charleston | SC | KCHS | Charleston/Charleston Air Force Base |
| Charleston | WV | KCRW | Charleston/Yeager Airport |
| Charlotte | NC | KCLT | Charlotte/Charlotte/Douglas International Airport |
| Charlottesville | VA | KCHO | Charlottesville/Charlottesville-Albemarle Airport |
| Chattanooga | TN | KCHA | Chattanooga/Lovell Field |
| Cheyenne | WY | KCYS | Cheyenne/Cheyenne Airport |
| Chicago/O'Hare | IL | KORD | Chicago/Chicago-O'Hare International Airport |
| Cincinnati | OH | KCVG | Covington/Cincinnati/Cincinnati/Northern Kentucky |
| | | | International Airport |
| Clarksburg | WV | KCKB | Clarksburg/Clarksburg Benedum Airport |
| Cleveland | OH | KCLE | Cleveland/Cleveland-Hopkins International Airport |
| Colorado Springs | CO | KCOS | Colorado Springs/City Of Colorado Springs Municipal Airport |
| Columbia | MO | KCOU | Columbia/Columbia Regional Airport |
| Columbia | SC | KCAE | Columbia/Columbia Metropolitan Airport |
| Columbus | OH | KCMH | Columbus/Port Columbus International Airport |
| Columbus | GA | KCSG | Columbus/Columbus Metropolitan Airport |
| Concord | NH | KCON | Concord/Concord Municipal Airport |
| Concordia | KS | KCNK | Concordia/Blosser Municipal Airport |
| Corpus Christi | TX | KCRP | Corpus Christi/Corpus Christi International Airport |
| Dallas | TX | KDFW | Dallas/Fort Worth/Dallas/Fort Worth International Airport |
| Dayton | OH | KDAY | Dayton/Cox Dayton International Airport |
| Daytona Beach | FL | KDAB | Daytona Beach/Daytona Beach Regional Airport |
| Del Rio | TX | KDRT | Del Rio/Del Rio International Airport |
| Denver | CO | KDEN | Denver/Denver International Airport |
| Des Moines | IA | KDSM | Des Moines/Des Moines International Airport |
| Detroit | MI | KDTW | Detroit/Detroit Metropolitan Wayne County Airport |
| Dickinson | ND | KDIK | Dickinson/Dickinson Municipal Airport |
| Dodge City | KS | KDDC | Dodge City/Dodge City Regional Airport |
| Dothan | AL | KDHN | Dothan/Dothan Regional Airport |
| Dover | DE | KDOV | Dover Air Force Base |
| Dubuque | IA | KDBQ | Dubuque/Dubuque Regional Airport |
| Duluth | MN | KDLH | Duluth/Duluth International Airport |
| Eau Claire | WI | KEAU | Eau Claire/Chippewa Valley Regional Airport |
| EI Paso | TX | KELP | EI Paso/EI Paso International Airport |
| Elkins | WV | KEKN | Elkins/Elkins-Randolph County-Jennings Randolph Field |
| Elmira | NY | KELM | Elmira/Elmira/Corning Regional Airport |
| Ely | NV | KELY | Ely/Ely Airport |
| Erie | PA | KERI | Erie/Erie International Airport |
| Eugene | OR | KEUG | Eugene/Mahlon Sweet Field |
| Evansville | IN | KEVV | Evansville/Evansville Regional Airport |
| Fargo | ND | KFAR | Fargo/Hector International Airport |
| Farmington | NM | KFMN | Farmington/Four Corners Regional Airport |
| Flagstaff | AZ | KFLG | Flagstaff/Flagstaff Pulliam Airport |
| Flint | MI | KFNT | Flint/Bishop International Airport |
| Florence | SC | KFLO | Florence/Florence Regional Airport |
| Fort Myers | FL | KFMY | Fort Myers/Page Field |
| Fort Smith | AR | KFSM | Fort Smith/Fort Smith Regional Airport |
| Fort Wayne | IN | KFWA | Fort Wayne/Fort Wayne International Airport |
| Fort Worth | TX | KFTW | Fort Worth/Meacham International Airport |
| Fresno | CA | KFAT | Fresno/Fresno Air Terminal |
| Gainesville | FL | KGNV | Gainesville/Gainesville Regional Airport |
| Glasgow | MT | KGGW | Glasgow/Glasgow International Airport |
| Goodland | KS | KGLD | Goodland/Renner Field |
| Grand Forks | ND | KGFK | Grand Forks/Grand Forks International Airport |
| Grand Island | NE | KGRI | Grand Island/Central Nebraska Regional Airport |
| Grand Junction | CO | KGJT | Grand Junction/Walker Field |
| Grand Rapids | MI | KGRR | Grand Rapids/Gerald R. Ford International Airport |
| Great Falls | MT | KGTF | Great Falls/Great Falls International Airport |
| Green Bay | WI | KGRB | Green Bay/Austin Straubel International Airport |
| Greensboro | NC | KGSO | Greensboro/Piedmont Triad International Airport |
| Greenville | SC | KGSP | Greer/Greenville-Spartanburg Airport |
| Gulfport | MS | KGPT | Gulfport/Gulfport-Biloxi Regional Airport |
| Harrisburg/Middletown | PA | KCXY | Harrisburg/Capital City Airport |
| Hartford | CT | KBDL | Windsor Locks/Bradley International Airport |
| Hatteras | NC | KHSE | Hatteras/Mitchell Field |
| Hattiesburg | MS | KHBG | Hattiesburg/Bobby L Chain Municipal Airport |
| Helena | MT | KHLN | Helena/Helena Regional Airport |
| Houghton Lake | MI | KHTL | Houghton Lake/Roscommon County Airport |
| Houston | TX | KIAH | Houston/Houston Intercontinental Airport |
| Huntington | WV | KHTS | Huntington/Tri-State Airport |
| Huntsville | AL | KHSV | Huntsville/Huntsville International/Jones Field |
| Huron | SD | KHON | Huron/Huron Regional Airport |
| Indianapolis | IN | KIND | Indianapolis/Indianapolis International Airport |
| International Falls | MN | KINL | International Falls/Falls International Airport |
| Jackson | KY | KJKL | Jackson/Carroll Airport |
| Jackson | MS | KJAN | Jackson/Jackson International Airport |
| Jackson | TN | KMKL | Jackson/McKellar-Sipes Regional Airport |
| Jacksonville | FL | KJAX | Jacksonville/Jacksonville International Airport |
| Jamestown | NY | KJHW | Jamestown Automatic Weather Observing/Reporting System |
| Jamestown | ND | KJMS | Jamestown/Jamestown Municipal Airport |
| Jonesboro | AR | KJBR | Jonesboro/Jonesboro Municipal Airport |
| Kalispell | MT | KFCA | Kalispell/Glacier Park International Airport |
| Kansas City | MO | KMCI | Kansas City/Kansas City International Airport |
| Key West | FL | KEYW | Key West/Key West International Airport |
| Knoxville | TN | KTYS | Knoxville/McGhee Tyson Airport |
| Lafayette | IN | KLAF | Lafayette/Purdue University Airport |
| Lake Charles | LA | KLCH | Lake Charles/Lake Charles Regional Airport |
| Lander | WY | KLND | Lander |
| Lansing | MI | KLAN | Lansing/Capital City Airport |
| Laredo | TX | KLRD | Laredo International Airport |
| Las Vegas | NV | KLAS | Las Vegas/McCarran International Airport |
| Lewiston | ID | KLWS | Lewiston/Lewiston-Nez Perce County Airport |
| Lexington | KY | KLEX | Lexington/Blue Grass Airport |
| Lincoln | NE | KLNK | Lincoln/Lincoln Municipal Airport |
| Little Rock | AR | KLIT | Little Rock/Adams Field |
| Los Angeles | CA | KLAX | Los Angeles/Los Angeles International Airport |
| Louisville | KY | KSDF | Louisville/Standiford Field |
| Lubbock | TX | KLBB | Lubbock/Lubbock International Airport |
| Lynchburg | VA | KLYH | Lynchburg/Lynchburg Regional Airport |
| Macon | GA | KMCN | Macon/Middle Georgia Regional Airport |
| Madison | WI | KMSN | Madison/Dane County Regional-Truax Field |
| Mansfield | OH | KMFD | Mansfield/Mansfield Lahm Municipal Airport |
| Marquette | MI | KMQT | Marquette |
| Medford | OR | KMFR | Medford/Rogue Valley International Airport |
| Memphis | TN | KMEM | Memphis/Memphis International Airport |
| Meriden | MS | KMEI | Meridian/Key Field |
| Miami | FL | KMIA | Miami/Miami International Airport |
| Midland | TX | KMAF | Midland/Midland International Airport |
| Miles City | MT | KMLS | Miles City/Frank Wiley Field Airport |
| Milwaukee | WI | KMKE | Milwaukee/General Mitchell International Airport |
| Minneapolis | MN | KMSP | Minneapolis/Minneapolis-St. Paul International Airport |
| Minot | ND | KMOT | Minot/Minot International Airport |
| Missoula | MT | KMSO | Missoula/Missoula International Airport |
| Mobile | AL | KMOB | Mobile/Mobile Regional Airport |
| Moline | IL | KMLI | Moline/Quad-City Airport |
| Monroe | LA | KMLU | Monroe/Monroe Regional Airport |
| Montgomery | AL | KMGM | Montgomery/Dannelly Field |
| Montpelier | VT | KMPV | Barre/Montpelier/Knapp State Airport |
| Muskegon | MI | KMKG | Muskegon/Muskegon County Airport |
| Nashville | TN | KBNA | Nashville/Nashville International Airport |
| New Orleans | LA | KMSY | New Orleans/New Orleans International Airport |
| New York | NY | KLGA | New York/La Guardia Airport |
| Newark | NJ | KEWR | Newark/Newark International Airport |
| Norfolk | NE | KOFK | Norfolk/Stefan Memorial Airport |
| Norfolk | VA | KORF | Norfolk/Norfolk International Airport |
| North Platte | NE | KLBF | North Platte/North Platte Regional Airport |
| Oklahoma City | OK | KOKC | Oklahoma City/Will Rogers World Airport |
| Olympia | WA | KOLM | Olympia/Olympia Airport |
| Omaha | NE | KOMA | Omaha/Eppley Airfield |
| Orlando | FL | KMCO | Orlando/Orlando International Airport |
| Ottumwa | IA | KOTM | Ottumwa/Ottumwa Industrial Airport |
| Palm Springs | CA | KPSP | Palm Springs/Palm Springs Regional Airport |
| Panama City | FL | KPFN | Panama City/Panama City-Bay County International Airport |
| Parkersburg | WV | KPKB | Parkersburg/Wood County Airport/Gill Robb Wilson Field |
| | | | Airport |
| Pendleton | OR | KPDT | Pendleton/Eastern Oregon Regional At Pendleton Airport |
| Pensacola | FL | KPNS | Pensacola/Pensacola Regional Airport |
| Peoria | IL | KPIA | Peoria/Greater Peoria Regional Airport |
| Philadelphia | PA | KPHL | Philadelphia/Philadelphia International Airport |
| Phoenix | AZ | KPHX | Phoenix/Phoenix Sky Harbor International Airport |
| Pierre | SD | KPIR | Pierre/Pierre Regional Airport |
| Pittsburgh | PA | KPIT | Pittsburgh/Pittsburgh International Airport |
| Pocatello | ID | KPIH | Pocatello/Pocatello Regional Airport |
| Portland | ME | KPWM | Portland/Portland International Jetport |
| Portland | OR | KPDX | Port Isabel/Portland International Airport |
| Prescott | AZ | KPRC | Prescott/Love Field |
| Price | UT | KPUC | Price/Carbon County Airport |
| Providence | RI | KPVD | Providence/Theodore Francis Green State Airport |
| Pueblo | CO | KPUB | Pueblo/Pueblo Memorial Airport |
| Quincy | IL | KUIN | Quincy/Quincy Regional-Baldwin Field Airport |
| Raleigh | NC | KRDU | Raleigh/Durham/Raleigh-Durham International Airport |
| Rapid City | SD | KRAP | Rapid City/Rapid City Regional Airport |
| Redding | CA | KRDD | Redding/Redding Municipal Airport |
| Reno | NV | KRNO | Reno/Reno Tahoe International Airport |
| Richmond | VA | KRIC | Richmond/Richmond International Airport |
| Roanoke | VA | KROA | Roanoke/Roanoke Regional Airport |
| Rochester | MN | KRST | Rochester/Rochester International Airport |
| Rochester | NY | KROC | Rochester/Greater Rochester International Airport |
| Rockford | IL | KRFD | Rockford/Greater Rockford Airport |
| Roswell | NM | KROW | Roswell/Roswell Industrial Air Center Airport |
| Sacramento | CA | KSAC | Sacramento/Sacramento Executive Airport |
| Salem | OR | KSLE | Salem/McNary Field |
| Salt Lake City | UT | KSLC | Salt Lake City/Salt Lake City International Airport |
| San Angelo | TX | KSJT | San Angelo/Mathis Field |
| San Antonio | TX | KSAT | San Antonio/San Antonio International Airport |
| San Diego | CA | KSAN | San Diego/San Diego International-Lindbergh Field |
| San Francisco | CA | KSFO | San Francisco/San Francisco International Airport |
| Santa Barbara | CA | KSBA | Santa Barbara/Santa Barbara Municipal Airport |
| Santa Fe | NM | KSAF | Santa Fe/Santa Fe County Municipal Airport |
| Sarasota | FL | KSRQ | Sarasota/Bradenton/Sarasota-Bradenton International Airport |
| Savannah | GA | KSAV | Savannah/Savannah International Airport |
| Scottsbluff | NE | KBFF | Scottsbluff/Heilig Field |
| Scranton | PA | KAVP | Wilkes-Barre-Scranton/Wilkes-Barre/Scranton International |
| | | | Airport |
| Seattle-Tacoma | WA | KSEA | Seattle/Seattle-Tacoma International Airport |
| Sheridan | WY | KSHR | Sheridan/Sheridan County Airport |
| Shreveport | LA | KSHV | Shreveport/Shreveport Regional Airport |
| Silver City | NM | KTCS | Truth Or Consequences/Truth Or Consequences Municipal |
| | | | Airport |
| Sioux City | IA | KSUX | Sioux City/Sioux Gateway Airport |
| Sioux Falls | SD | KFSD | Sioux Falls/Foss Field |
| South Bend | IN | KSBN | South Bend/South Bend Regional Airport |
| Spokane | WA | KGEG | Spokane/Spokane International Airport |
| Springfield | MO | KSGF | Springfield/Springfield Regional Airport |
| Springfield | IL | KSPI | Springfield/Capital Airport |
| St. Cloud | MN | KSTC | St. Cloud/St. Cloud Municipal Airport |
| St. Louis | MO | KSTL | St. Louis/Lambert-St. Louis International Airport |
| Syracuse | NY | KSYR | Syracuse/Syracuse Hancock International Airport |
| Tallahassee | FL | KTLH | Tallahassee/Tallahassee Regional Airport |
| Tampa | FL | KTPA | Tampa/Tampa International Airport |
| Toledo | OH | KTOL | Toledo/Toledo Express Airport |
| Topeka | KS | KTOP | Topeka/Philip Billard Municipal Airport |
| Traverse City | MI | KTVC | Traverse City/Cherry Capital Airport |
| Tucson | AZ | KTUS | Tucson/Tucson International Airport |
| Tulsa | OK | KTUL | Tulsa/Tulsa International Airport |
| Tupelo | MS | KTUP | Tupelo/Tupelo Regional Airport |
| Valentine | NE | KVTN | Valentine/Miller Field |
| Victoria | TX | KVCT | Victoria/Victoria Regional Airport |
| Waco | TX | KACT | Waco/Waco Regional Airport |
| Washington | DC | KDCA | Washington DC/Reagan National Airport |
| Washington/Dulles | VA | KIAD | Washington DC/Washington-Dulles International Airport |
| Waterloo | IA | KALO | Waterloo/Waterloo Municipal Airport |
| Wausau | WI | KAUW | Wausau/Wausau Downtown Airport |
| West Palm Beach | FL | KPBI | West Palm Beach/Palm Beach International Airport |
| Wichita | KS | KICT | Wichita/Wichita Mid-Continent Airport |
| Wichita Falls | FX | KSPS | Wichita Falls/Sheppard Air Force Base |
| Williamsport | PA | KIPT | Williamsport/Williamsport-Lycoming County Airport |
| Williston | ND | KISN | Williston/Sloulin Field International Airport |
| Wilmington | NC | KILM | Wilmington/New Hanover International Airport |
| Wilmington | DE | KILG | Wilmington/New Castle County Airport |
| Winnemucca | NV | KLOL | Lovelock/Derby Field Airport |
| Worcester | MA | KORH | Worcester/Worcester Regional Airport |
| Yakima | WA | KYKM | Yakima/Yakima Air Terminal |
| Youngstown | OH | KYNG | Youngstown/Youngstown-Warren Regional Airport |
| Yuma | AZ | KNYL | Yuma/Marine Corps Air Station |

1. A method for making a forecast of a weather condition for a time period in a year in accordance with actual data for the weather condition for the time period in two previous years and a normal value for the weather condition in the time period, the method comprising:
(a) calculating a first difference between the actual data for the weather condition for the time period for one of the previous years and the normal value for the weather condition for the time period;
(b) determining whether the first difference is above, below or within a predetermined range;
(c) if the first difference is above the predetermined range, calculating the forecast in accordance with a first formula;
(d) if the first difference is below the predetermined range, calculating the forecast in accordance with a second formula; and
(e) if the first difference is within the range:
(i) calculating an average value of the weather condition for the time period in the two previous years;
(ii) calculating a second difference between the average value and the normal value;
(iii) determining whether the second difference is above, below or within the predetermined range;
(iv) if the second difference is above the predetermined range, calculating the forecast in accordance with the first formula;
(v) if the second difference is below the predetermined range, calculating the difference in accordance with a third formula; and
(vi) if the second difference is within the predetermined range, using the normal value as the forecast.

2. The method of claim 1, wherein the weather condition comprises temperature.

3. The method of claim 2, wherein step (a) comprises calculating an average value of the temperature for the time period and calculating the difference from the average value.

4. The method of claim 1, wherein the weather condition comprises precipitation.

5. The method of claim 4, wherein step (a) comprises calculating a total value of the precipitation for the time period and calculating the difference from the total value.

6. The method of claim 1, wherein steps (a)-(e) are performed for temperature and also for precipitation.

7. The method of claim 1, wherein the time period is one week.

8. The method of claim 7, wherein steps (a)-(e) are performed for all weeks in a month to provide the forecast for all of the weeks in the month.

9. The method of claim 8, wherein steps (a)-(e) are performed for all weeks in a plurality of months to provide the forecast the all of the weeks in the plurality of months.

10. The method of claim 9, further comprising providing a printed publication indicating the forecast for all of the weeks in the plurality of months.

11. The method of claim 10, wherein the printed publication includes a graphical view of the forecast as a function of time.

12. The method of claim 11, wherein the printed publication further includes a graphical view of the forecast as a function of geographical location.

13. The method of claim 11, wherein the printed publication further includes a graphical view of optimal advertising times determined from the forecast.

14. The method of claim 1, further comprising outputting the forecast as a digital data feed to a remote system.

15. The method of claim 1, wherein:
the weather condition has a normal value Vₙₒᵣₘ, an actual value for last year LYV_{act}, and an actual value for the year before last year LLYV_{act};
the first formula is
LY V_{act}−[(LY V_{act}−Vₙₒᵣₘ)×0.75]=FORECAST;
the second formula is
LY V_{act}+[ABS((LY V_{act}−V norm)×0.75)]=FORECAST; and
the third formula is
(LLY V_{act}+LY V_{act})/2+[ABS((((LLY V_{act}+LY V_{act})/2)−V norm)×0.75)]=FORECAST.

16. A system for making a forecast of a weather condition for a time period in a year in accordance with actual data for the weather condition for the time period in two previous years and a normal value for the weather condition in the time period, the system comprising:
an input for receiving the actual data;
a computing device, in communication with the input, for:
(a) calculating a first difference between the actual data for the weather condition for the time period for one of the previous years and the normal value for the weather condition for the time period;
(b) determining whether the first difference is above, below or within a predetermined range;
(c) if the first difference is above the predetermined range, calculating the forecast in accordance with a first formula;
(d) if the first difference is below the predetermined range, calculating the forecast in accordance with a second formula; and
(e) if the first difference is within the range:
(i) calculating an average value of the weather condition for the time period in the two previous years;
(ii) calculating a second difference between the average value and the normal value;
(iii) determining whether the second difference is above, below or within the predetermined range;
(iv) if the second difference is above the predetermined range, calculating the forecast in accordance with the first formula;
(v) if the second difference is below the predetermined range, calculating the difference in accordance with a third formula; and
(vi) if the second difference is within the predetermined range, using the normal value as the forecast; and
an output, in communication with the computing device, for outputting the forecast.

17. The system of claim 16, wherein the output comprises an output to a page setting and printing system for producing a hard copy representing the forecast.

18. The system of claim 16, wherein the output comprises a communication link for making a digital data feed to a remote system.
